(19) United States
(12) Patent Application Publication
(10) Pub. No.: US 2014/0379782 A1
(43) Pub. Date: Dec. 25, 2014

(54) COMPUTER-READABLE RECORDING MEDIUM STORING DATA ASSOCIATION PROGRAM AND DATA ASSOCIATION METHOD

(71) Applicant: FUJITSU LIMITED, Kawasaki-shi (JP)

(72) Inventors: Shinta TAKECHI, Yokohama (JP); Atsushi SHIMANO, Kawasaki (JP); Takehiro IDE, Mishima (JP)

(21) Appl. No.: 14/310,529

(22) Filed: Jun. 20, 2014

(30) Foreign Application Priority Data
Jun. 21, 2013 (JP) 2013-130965

(51) Int. Cl. H04L 29/06

(52) U.S. Cl. CPC H04L 67/42
USPC 709/203

(57) ABSTRACT

A non-transitory computer-readable recording medium storing a data association program that causes a computer execute a process. The process includes: transmitting first function data representing a first function called by a first computation processing device that executes a specific program in which a specific function is defined; and in response to receipt of second function data representing a second function, and identification data representing a second data processing device, from the second data processing device which executes, in accordance with receipt of the transmitted first function data, a program including the second function which is cross-referenced by the first function, associating the second function data and the identification data with the first function data.

### CROSS-REFERENCE TO RELATED APPLICATION

This application is based upon and claims the benefit of priority of the prior Japanese Patent Application No. 2013-130965, filed on Jun. 21, 2013, the entire contents of which are incorporated herein by reference.

### FIELD

The embodiments discussed herein are related to a storage medium having stored therein a non-transitory computer-readable recording medium storing data association program, and a data association method.

### BACKGROUND

There are programs in which an object stored on a server device is called from a client terminal, and processing based on the called object is executed on the client terminal. Technology is known in which a naming service is used to specify the location of the called object when the object stored on the server device is called. For example, the client terminal dispatches a search request that includes the object name to the server device that provides the naming service, and cross-reference data representing the location of the object is received from the server device in response to the search request. The client terminal executes processing using the object on the basis of the received cross-reference data.

Technology is also known in which a directory service is used to specify the location of an object stored on a server device. In cases in which a service provided is an example of an object, for an enquiry by a client terminal to a server device to perform a service search on a network, or to provide a directory service that makes a listing, the server device returns a service list to the client terminal.

Technology is also known in which, in order to specify the location of an object stored on a server device, a server device that holds the object, out of plural server devices, is made to respond. In the technology in which the server device holding the object is made to respond, when the system receives the enquiry for the object location from the client terminal, the relevant object is searched for in plural servers, and the response to the client terminal is transmitted by the relevant server.

Moreover, as an example of a case in which the location of an object is specified, technology is known in which the origin of a Java (registered trademark) applet is certified. In the technology in which the origin of the Java (registered trademark) applet is certified, a hash value of deployment data representing a definition present in the Java (registered trademark) applet is requested, enabling certification of the origin of the Java (registered trademark) applet by confirming sameness to the hash value at the time of activation.

### RELATED PATENT DOCUMENTS

Japanese Laid-Open Patent Publication No. 2004-30486
Japanese Laid-Open Patent Publication No. 2001-325183
Japanese Laid-Open Patent Publication No. 2001-67377
International Publication (WO) No. 2006/016407

### SUMMARY

According to an aspect of the embodiments, there is provided a non-transitory computer-readable recording medium storing a data association program that causes a computer to execute a process including: transmitting first function data representing a first function called by a first computation processing device that executes a specific program in which a specific function is defined; and in response to receipt of second function data representing a second function, and identification data representing a second data processing device, from the second data processing device which executes, in accordance with receipt of the transmitted first function data, a program including the second function which is cross-referenced by the first function, associating the second function data and the identification data with the first function data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a data association system;

FIG. 2 is a block diagram illustrating an example of a data association system implemented by a computer system;

FIG. 3 is an explanatory diagram illustrating operation of the computer system;

FIG. 4 is an illustration of an example of a table in which a server device is registered;

FIG. 5 is an illustration of an example of a table storable on a client device;

FIG. 6 is a flow chart illustrating an example of registration processing flow of a table on the server device;

FIG. 7 is a flow chart illustrating an example of a flow of provision processing for host data of the server device;

FIG. 8 is a flow chart illustrating an example of a flow of association processing between connection data with call data on the client device;

FIG. 9 is an explanatory diagram illustrating operation of the computer system;

FIG. 10 is an illustration of an example of a display screen for selection designation of host data;

FIG. 11 is a flow chart illustrating an example of a flow of execution processing in the client device;

FIG. 12 is a block diagram illustrating an example of a data association system implemented by a computer; and

FIG. 13 is an explanatory diagram relating to a data processing system according to a comparative example.

### DESCRIPTION OF EMBODIMENTS

An example of an embodiment of technology disclosed herein is described in detail below with reference to the drawings.

Note that in the present exemplary embodiment, an exemplary case is explained in which technology disclosed herein is applied to a case in which program components are created in the Java (registered trademark) language, a programming language, and objects that are the program components are combined together to construct an application program. In the present exemplary embodiment, explanation is given relating to an application program in the Java (registered trademark) language; however, technology disclosed herein is not limited to application programs in the Java (registered trademark) language.

For example, platforms exist that group together functions employed by a server device (platforms known as Enterprise Java (registered trademark)) when a program component in the Java (registered trademark) language is included in an application program and employed. A platform known as Enterprise Java (registered trademark) Beans (EJB) exists as one of the platforms known as Enterprise Java (registered trademark). In some cases, EJB application programs created to conform to the platform known as EJB are implemented by a web server or the like. The platform known as EJB is a platform that combines the platform known as Java (registered trademark) Beans with functionality employing processing executed by an application program on a server device. The platform known as Java (registered trademark) Beans is a platform in which program components are created in the Java (registered trademark) language, and objects that are the program components are combined together to construct an application program.

### COMPARATIVE EXAMPLE

Prior to the explanation of technology disclosed herein, a comparative example is first explained, with reference to the drawings.

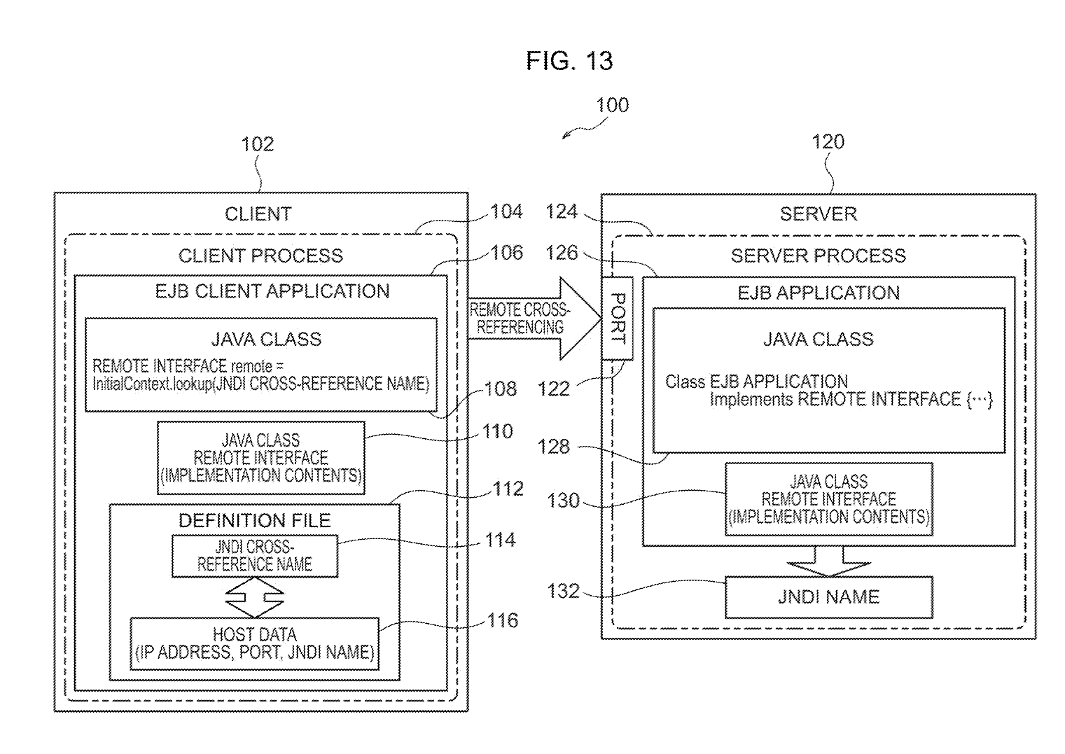

A configuration of a data processing system 100 is illustrated in FIG. 13 according to the comparative example. The data processing system 100 includes a client device 102 and a server device 120. A client process 104 is executed on the client device 102. The client process 104 includes an EJB client application 106 that functions according to the execution of an EJB client application program. Data 108 representing an object that makes calls via a remote interface, and data 110 representing contents of the remote interface, are defined in the EJB client application 106. A Java (registered trademark) Naming and Directory Interface (JNDI) name is an example of the data 108. Data representing methods, parameters, and the like relating to the remote interface are examples of the data 110 representing contents.

Moreover, a server process 124 is executed on the server device 120. The server process 124 includes an EJB application 126 that functions by execution of an EJB application program. Data 128 representing objects provided through the remote interface, and data 130 representing the contents of the remote interface are defined in the EJB application 126. In FIG. 13, a case is illustrated in which data 132, representing a JNDI name that serves as data representing an object of the EJB application 126, is automatically generated.

For example, there are cases in which the EJB client application 106 that is executed on the client device 102 executes remote call processing, with the EJB application 126 that executes on the server device 120 acting as an object. In cases in which remote call processing is executed, in order to specify the object being called, data relating to the object called is defined in the EJB client application 106. Namely, data associating the connection data of the EJB application 126 to be called with call data of the EJB client application 106 are pre-registered as a definition file in the EJB client application 106. Note that there are cases in which the associations between the connection data and the call data are known as JNDI mapping. In FIG. 13, as an example of connection data, host data 116 is annotated with an included IP address associated with the server device 120, the number of a port 122 that is to be employed, and the JNDI name. Moreover, as an example of call data, data 114 representing a JNDI cross-reference name is annotated with the JNDI name to specify, as an argument for a lookup method of an InitialContext class. Namely, in FIG. 13, data relating the data 114 representing JNDI cross-reference names to host data 116 are pre-recorded in a definition file 112.

In cases in which the custom definition file 112 that relates to the server device 120 and the server process 124 is incorporated in the EJB client application 106, the definition file 112 is manually re-set when the settings of the EJB application 126 are changed. The definition file 112 is also manually re-set when the configuration of the server device 120 changes. Consequently, when the data changes in the server device 120, there is an increase in the procedures for the user to re-set the definition file 112, and processing becomes cumbersome.

There are cases in which plural server devices include objects that have the same JNDI name. However, even though the JNDI name might be the same, the operation of the called EJB application 126 is not necessarily the same. Consequently, there is increased work by the user to manually confirm whether the remote interface of the server device 120 side having the same JNDI name is the same, or is not the same, to the remote interface of the client device 102 side. For example, it cannot be distinguished from the data 132 representing the JNDI name whether the contents of the remote interface implemented by the EJB application 126, and the remote interface implemented by the EJB client application 106 on the call side, are the same or not the same as each other. Consequently, there is an increase in the work to manually confirm the contents of the remote interface. As an example of the contents of the remote interface, there is data to represent a method count, parameters, and exceptions.

In an exemplary embodiment, as explained in detail below, for example, an EJB application with the same remote interface contents is selected, from out of EJB applications connectable from the EJB client application, and corresponded with the data.

### First Exemplary Embodiment

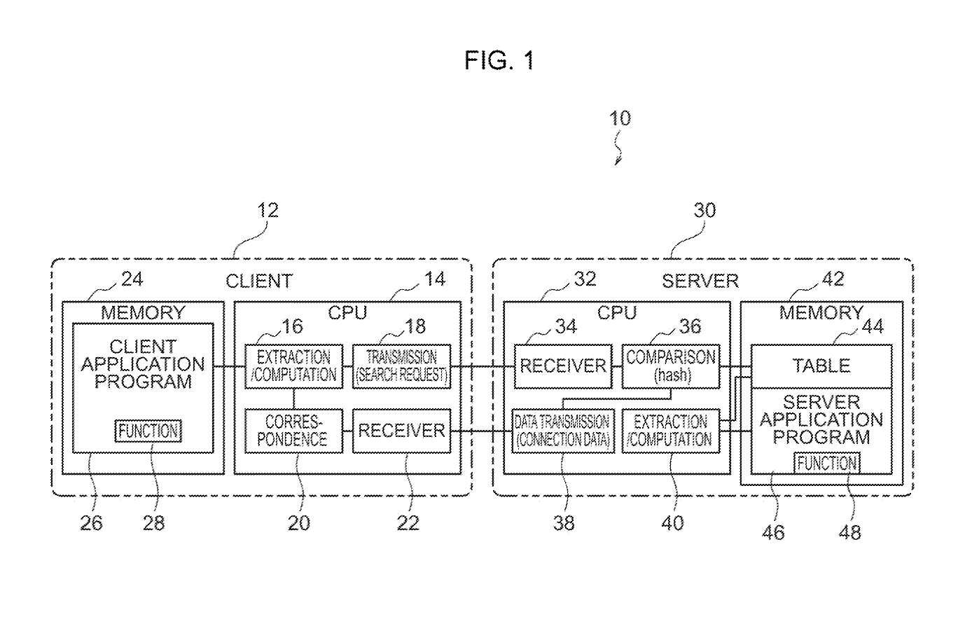

FIG. 1 illustrates an example of a data association system 10 according to the present exemplary embodiment. The data association system 10 is an example of a server client system to which a data association program and a data association method of technology disclosed herein are applicable. The data association system 10 is provided with a client device 12 and a server device 30. The client device 12 includes a CPU 14 and memory 24, and a client application program 26 is stored in the memory 24 as a target program that includes a function 28 for associating data. Note that when the client application program 26 is executed in the client device 12, the function 28 is called by the CPU 14, and a function 48 executed on the server device 30 that is associated with the function 28, is acquired as an object. The CPU 14 of the client device 12 operates as an extraction/computation section 16, a transmission section 18, a correspondence section 20, and a receiver section 22 by executing an association program that associates data with the function 28.

The server device 30 includes a CPU 32 and memory 42, and the memory 42 stores a server application program 46 that includes the function 48 to be provided as an object. The memory 42 stores a table 44, for the function 48, representing data for provision as an object. Data representing a correspondence relationship between the name of the function 48 and each type of data such as parameters used when the function 48 is employed are an example of data for provision as an object. Note that for each type of data, such as parameters used when the function 48 is employed, each of the data types may be stored as distinctly specifiable unique data by requesting data representing a computation result of a one-way function. The CPU 32 of the server device 30 operates as a receiver section 34, a comparison section 36, an extraction/computation section 40, and a data transmission section 38 by executing a management program that manages the function 48.

The table 44 is pre-registered in the server device 30 of the data association system 10. Namely, in the server device 30, execution of the management program by the CPU 32 of the server device 30 results in the extraction/computation section 40 extracting the function 48 provided as an object, and a computation result is obtained from the one-way function input with data representing the extracted function 48. The extraction/computation section 40 registers the computation result of the one-way function in the table 44, in correspondence with data representing the name of the extracted function 48. In the client device 12 of the data association system 10, the CPU 14 calls the function 28, and in order to acquire the function 48 of the server device 30 as an object, the CPU 14 executes the data association program. The execution of the data association program results in the extraction/computation section 16 of the client device 12 extracting the function 28 that is included in the client application program 26. The extraction/computation section 16 requests the computation result of the one-way function input with the data representing the extracted function 28. The transmission section 18 transmits the computation result of the extraction/computation section 16 to the server device 30. Namely, the transmission section 18 transmits data representing the function 28 called by the CPU 14 that executes the client application program 26 in which the function 28 is defined.

In the server device 30, the receiver section 34 receives the computation result of the one-way function representing the function 28, and, using the table 44, the comparison section 36 identifies data representing the function 48 that has a one-way function computation result that is the same as that of the received one-way function computation result. The data representing the identified function 48 is transmitted to the client device 12 by the data transmission section 38. The data transmitted by the data transmission section 38 includes data representing the name of the specified function 48, and data representing the server device 30. The data representing the function 48 and the data representing the server device 30 that have been transmitted from the server device 30 are corresponded in the client device 12 with the data representing the called function 28. Namely, the receiver section 22 receives the data transmitted from the server device 30, and, in the correspondence section 20, the data representing the function 48 and the data representing the server device 30 transmitted from the server device 30 are corresponded with the data representing the called function 28. This thereby enables correspondence of the data representing the function 28 called by the CPU 14 that executes the client application program 26, with the data representing the function 48 that is cross-referenced by the called function 28.

The data association system 10 serves as an example of a data association system of technology disclosed herein. The transmission section 18 serves as an example of a first transmission section of technology disclosed herein. The data transmission section 38 serves as an example of a second transmission section of technology disclosed herein. The correspondence section 20 serves as an example of a correspondence section of technology disclosed herein.

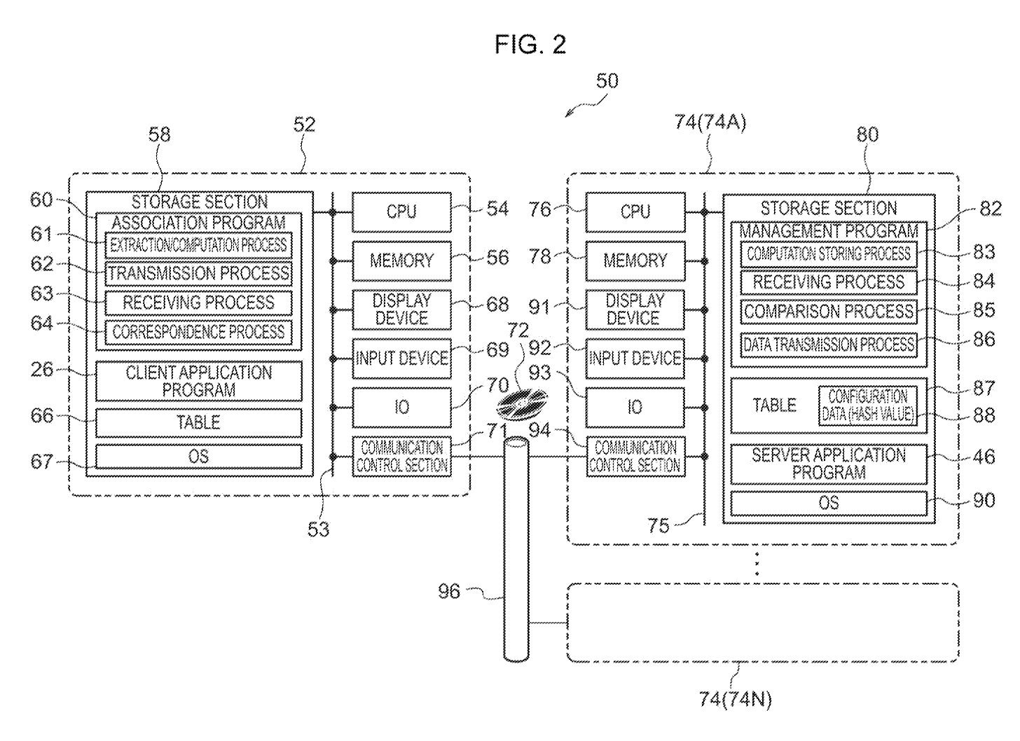

FIG. 2 illustrates an example of the data association system 10 implemented by a computer system 50. The computer system 50 includes a client device 52 and plural server devices 74, with both the client device 52 and the server devices 74 connected to a computer network 96. Note that in cases in which each of the plural server devices 74 individually act as the target, they are denoted as server devices 74A to 74N in order to handle the server devices 74 separately. The client device 52 is provided with a CPU 54, memory 56, and a non-volatile storage section 58. The CPU 54, the memory 56, and the storage section 58 are mutually connected through a bus 53. The client device 52 is also provided with a display device 68 and an input device 69, and the display device 68 and the input device 69 are connected to the bus 53. A communication control section 71 for connection to the computer network 96, and a device (IO device) 70 for read/writing a storage medium 72 when inserted, are also connected to the bus 53 in the client device 52. Note that the storage section 58 may be implemented as a Hard Disk Drive (HDD), flash memory, or the like.

The storage section 58 stores an association program 60 that serves as an example of a program for causing the computer system 50 to function as a section of the data association system 10. The association program 60 includes an extraction/computation process 61, a transmission process 62, a receiving process 63, and a correspondence process 64. The CPU 54 reads the association program 60 from the storage section 58 and expands the association program 60 into the memory 56, and the client device 52 operates as the client device 12, illustrated in FIG. 1, by sequentially executing the processes included in the association program 60. The client device 52 operates as the extraction/computation section 16 of the client device 12, illustrated in FIG. 1, by the CPU 54 executing the extraction/computation process 61, and operates as the transmission section 18, illustrated in FIG. 1, by the CPU 54 executing the transmission process 62. The client device 52 operates as the receiver section 22 of the client device 12, illustrated in FIG. 1, by the CPU 54 executing the receiving process 63, and operates as the correspondence section 20, illustrated in FIG. 1, by the CPU 54 executing the correspondence process 64.

The client application program 26 is stored as the target program in the storage section 58. Data representing the function 28 called by the CPU 54 executing the client application program 26, and data representing the function 48 for cross-referencing against the called function 28, are stored in a correspondence table 66 in the storage section 58. An Operating System (OS) 67 is also stored in the storage section 58.

The server device 74 is provided with a CPU 76, memory 78, and a non-volatile storage section 80. The CPU 76, the memory 78, and the storage section 80 are mutually connected through a bus 75. The server device 74 is provided with a display device 91 and an input device 92, and the display device 91 and the input device 92 are connected to the bus 75. The server device 74 includes a communication control section 94 for connection to the computer network 96, and a device (IO device) 93 for read/writing from the storage medium 72 when inserted, that are also connected to the bus 75. Note that the storage section 80 may be implemented by an HDD, flash memory, or the like.

The storage section 80 stores a management program 82 that serves as an example of a program for causing the computer system 50 to function as a section of the data association system 10. The management program 82 includes a computation storing process 83, a receiving process 84, a comparison process 85, and a data transmission process 86. The CPU 76 reads the management program 82 from the storage section 80 and expands the management program 82 into the memory 78, and the server device 74 operates as the server device 30 illustrated in FIG. 1 by sequentially executing the processes included in the management program 82. The server device 74 operates as the extraction/computation section 40 of the server device 30, illustrated in FIG. 1, by the CPU 76 executing the computation storing process 83, and operates as the receiver section 34, illustrated in FIG. 1, by the CPU 76 executing the receiving process 84. The server device 74 operates as the comparison section 36, illustrated in FIG. 1, by the CPU 76 executing the comparison process 85, and operates as the data transmission section 38, illustrated in FIG. 1, by the CPU 76 executing the data transmission process 86.

The server application program 46 is stored in the storage section 80. The storage section 80 also stores a table 87 representing the correspondence relationship between the name of the function 48 provided as an object, with each type of data, such as the parameters when employing the function 48. For each type of data, such as parameters, registered in the table 87, a hash value 88 is stored as configuration data, this being the computation result for the function 48 according to a hash function, which is an example of the one-way function. The storage section 80 also stores a server Operating System (OS) 90.

Explanation next follows regarding operation of the present exemplary embodiment. A simple explanation will first be given regarding association of connection data of the EJB application called from the client side, with call data of the EJB client application, by operation of the computer system 50.

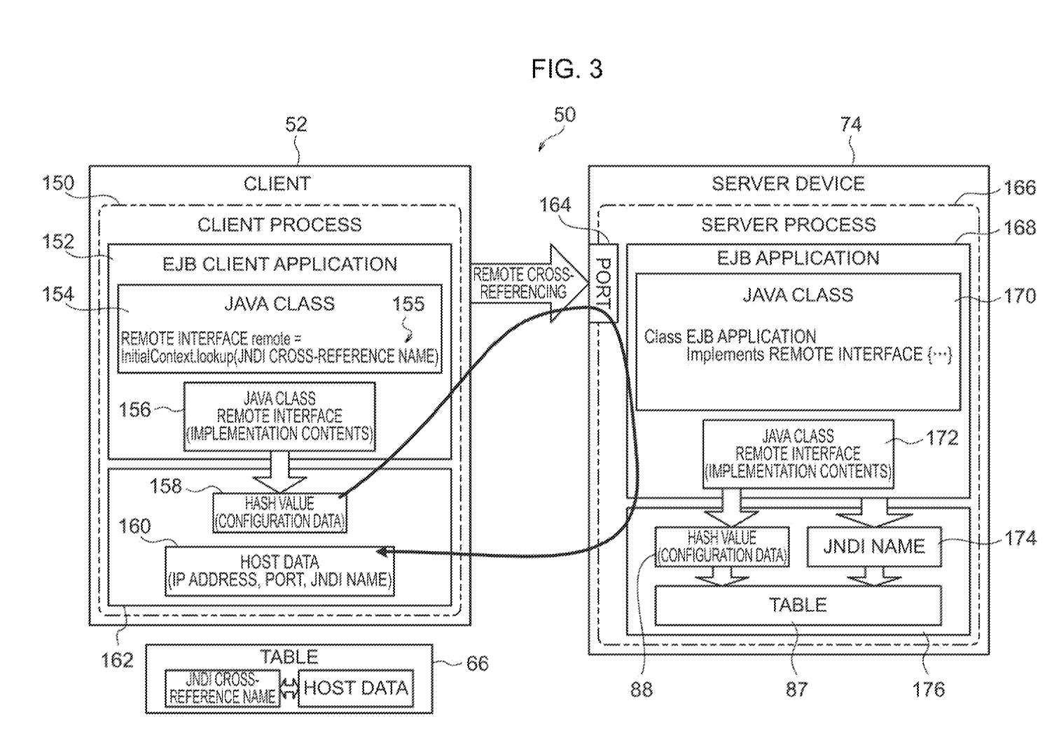

FIG. 3 is a diagram illustrating an explanation of the operation of the computer system 50. For the sake of simple explanation, FIG. 3 illustrates an example in which the computer system 50 includes the client device 52 and one of the server devices 74. In order to execute remote calling of the EJB application, the client device 52 of the computer system 50 executes a process that associates the connection data of the called EJB application with the call data of the EJB client application.

A server process 166 is executed by the server device 74. The server process 166 includes an EJB application 168 that functions by executing the server application program 46. Data 170 representing an object provided by the remote interface, and data 172 representing the contents of the remote interface, are defined in the EJB application 168. Note that in the server device 74, data 174 representing the JNDI name is generated automatically by the EJB application 168, as data representing an object.

The server process 166 of the server device 74 includes a management application 176 that functions by execution of the management program 82. The management application 176 requests the hash value 88 of the data 172 representing the contents of the remote interface, and has the function of registering data that associates the hash value 88 with the data 174 representing the JNDI name as a table 87. The management application 176 has the functions of referencing the table 87, and transmitting host data 160 when a remote interface is included that has a hash value that is the same as a hash value 158 transmitted from the client device 52. Examples of the host data include the IP address of the server device 74, the port number of a port 164, and the respective data 174 representing each JNDI name.

A client process 150 is executed by the client device 52. The client process 150 includes an EJB client application 152 that functions by execution of the client application program 26. Data 154 representing an object called via the remote interface, and data 156 representing the contents of the remote interface are defined in the EJB client application 152. In the present exemplary embodiment, a JNDI cross-reference name 155 is employed as an example of the data 154, and data representing methods, parameters, and the like of the remote interface are employed as an example of the data 156 representing the contents.

The client process 150 of the client device 52 includes an association application 162 that functions by execution of the association program 60. The association application 162 requests the hash value 158 of the data 156 representing the contents of the remote interface, and has the function of finding the data 174 representing the JNDI name of the matching hash value 158, from the server device 74. The association application 162 receives the host data 160, for connecting to the remote interface having a hash value that is the same as the hash value 158, and has the function of associating the JNDI cross-reference name 155 and the host data 160. The data associating the JNDI cross-reference name 155 with the host data 160 may be stored as the table 66.

Consequently, in the computer system 50, the client device 52 is able to receive the host data 160 pertaining to the remote interface having the same remote interface hash value, enabling the connectable EJB application 168 in the server device 74 to be specified.

Note that the data 156, representing the contents of the remote interface of the EJB client application 152, is an example of a function of technology disclosed herein. The data representing the computation result of the one-way function for the data 156 representing the contents of the remote interface of the EJB client application 152, are an example of the configuration data of technology disclosed herein.

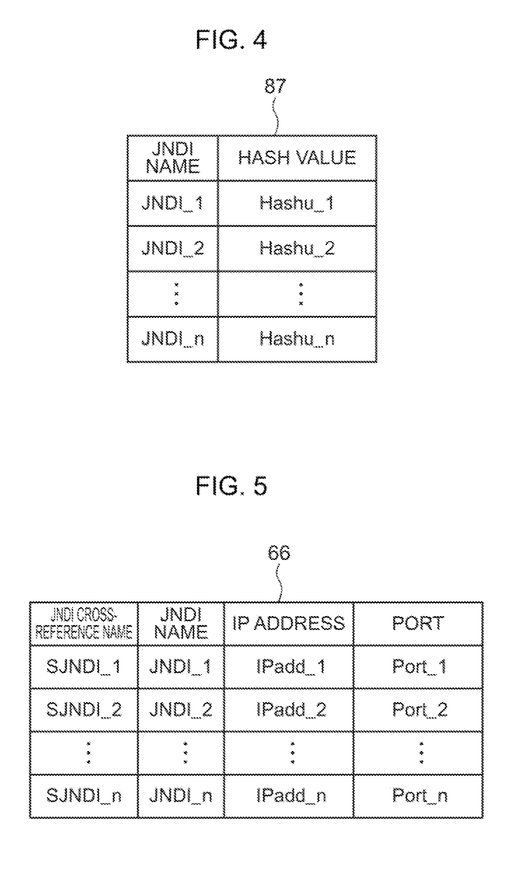

FIG. 4 illustrates an example of the table 87 that is registered in the server device 74. FIG. 4 illustrates the table 87 containing the correspondence relationships of the data representing JNDI names, with the data representing hash values of remote interfaces corresponding to the JNDI names. FIG. 5 illustrates an example of the table 66 storable in the client device 52. FIG. 5 illustrates the table 66 in which the data representing the JNDI cross-reference names that represent data to be called by the client device 52 are corresponded with host data, including respective data of the JNDI names in the server device 74, IP addresses, and port numbers.

Detailed explanation will next be given regarding processing of relationships between the connection data of the EJB application called from the client side, and the call data of the EJB client application, through the operation in the computer system 50. Note that a case is explained in which the client device 52 included in the computer system 50, and the plural server devices 74 are running on the same network segment on the computer network 96.

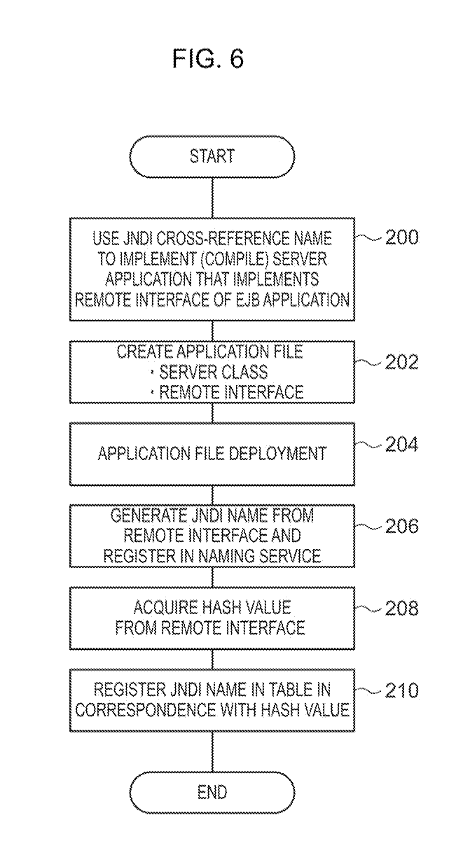

An example of registration processing flow of the table 87 pre-executed on the server device 74 is illustrated in FIG. 6. The registration processing of the table 87 is executed, for example, by the server device 74 when the EJB application 168 is implemented. The registration processing of the table 87 is a process performed by a portion of the executed management program 82, and is an example of the association program of technology disclosed herein. The registration processing of the table 87, illustrated in FIG. 6, is a process performed by execution of the computation storing process 83 of the management program 82.

First, the CPU 76 of the server device 74 initiates execution of the computation storing process 83 of the management program 82. Specifically, at step 200, the CPU 76 employs a JNDI cross-reference name and implements (compiles) the server application that implements the remote interface of the EJB application 168. At step 202, an application file is created. The server class and the remote interface are added in the creation of the application file. Next, at step 204, the CPU 76 deploys the created application file, namely, puts the application in an employable state. Note that the processes of step 200 to step 204 are executed according to manual procedures by the user, and are known technology for deploying application files, and detailed explanation thereof is omitted.

Next, at step 206, the CPU 76 creates a JNDI name from the remote interface, and registers the JNDI name in the naming service.

Next, at step 208, the CPU 76 acquires the hash value 88 from the remote interface. Namely, the CPU 76 inputs the remote interface into the one-way function, and acquires the hash value 88 by obtaining the computation result, or by employing the serialized value of the remote interface. Next, the CPU 76 corresponds the JNDI name created at step 206 against the hash value 88 acquired at step 208 and registers the correspondence in the table 87, and the process routine terminates.

Detailed explanation will next be given regarding processing, in the computer system 50 on the server device 74, when the EJB application is called from the client side. Note that the processing in the client device 52 to call the EJB application is described later.

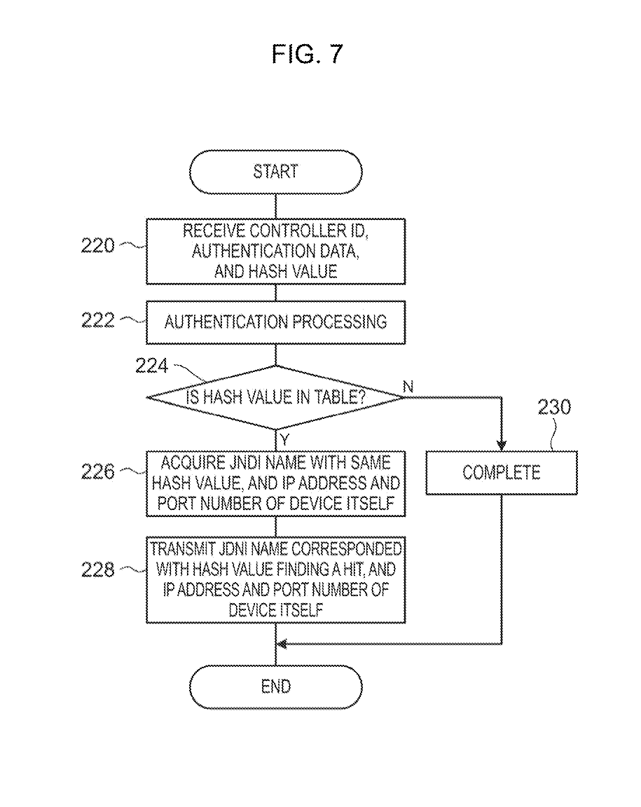

FIG. 7 illustrates an example of processing executed on the server device 74 when a request is made by the client device 52 for data to be employed for calling the EJB application, namely, illustrates an example of flow of provision processing of the host data. The provision processing of the host data is executed on the server device 74 when provision of host data is requested from the client device 52. The provision processing of the host data is a process performed by a portion of the management program 82, executed as an example of an association program of technology disclosed herein. The provision processing of the host data illustrated in FIG. 7 is processing performed by execution of the receiving process 84, the comparison process 85, and the data transmission process 86 of the management program 82.

First, the CPU 76 of the server device 74 initiates sequential execution of the receiving process 84, the comparison process 85, and the data transmission process 86 of the management program 82. Specifically, the processing routine illustrated in FIG. 7 is executed when the CPU 76 receives from the client device 52 data representing a provision request for the host data 160. At step 220, the CPU 76 receives a controller ID, authentication data, and the hash value 158. The controller ID is predetermined identification data for a control process corresponding to a request for data (the host data 160) that the client device 52 employs to call the EJB application. The authentication data is data used in authentication when the client device 52 connects to the server device 74. The hash value 158 is data representing the computation result of the one-way function for the data 156 representing the contents of the remote interface of the EJB client application 152 (described in detail later).

Next, at step 222, the CPU 76 executes authentication processing, and confirms that the request is from the authentic client device 52. Note that when the authentication processing fails at step 222, the CPU 76 does not proceed with the processing, and the processing routine is terminated, but when authentication processing is successful, processing transitions to step 224. Next, at step 224, the CPU 76 cross-references the table 87, and determines whether or not there is a hash value 88 already registered in the table 87 that is the same as the hash value 158 received at step 220. The CPU 76 distinguishes that the EJB application that includes the remote interface requested by the client device 52 is not included (a negative determination at step 224) when the hash value 88 is not registered in the table 87, all processing is completed at step 230, and the processing routine terminates.

The CPU 76 distinguishes that the EJB application 168 requested by the client device 52 is included (a positive determination at step 224) when the hash value 88 that is the same as the hash value 158 is already registered in the table 87, and processing transitions to step 226. Next, at step 226, the CPU 76 acquires the JNDI name corresponded with the hash value 88 and the IP address and the port number of the device itself, and then, at step 228, transmits the acquired JNDI name, the IP address and the port number of the device itself, as the host data 160.

Note that the processing at step 204 to step 210 illustrated in FIG. 6, corresponds to the processing of the computation storing process 83 (FIG. 2). In FIG. 7, the processing at step 220 corresponds to the processing of the receiving process 84 (FIG. 2), the processing at step 222 corresponds to the processing of the comparison process 85, and the processing at steps 226 and 228 corresponds to the processing of the data transmission process 86.

Detailed explanation will next be given regarding the processing by the client device 52 in the computer system 50.

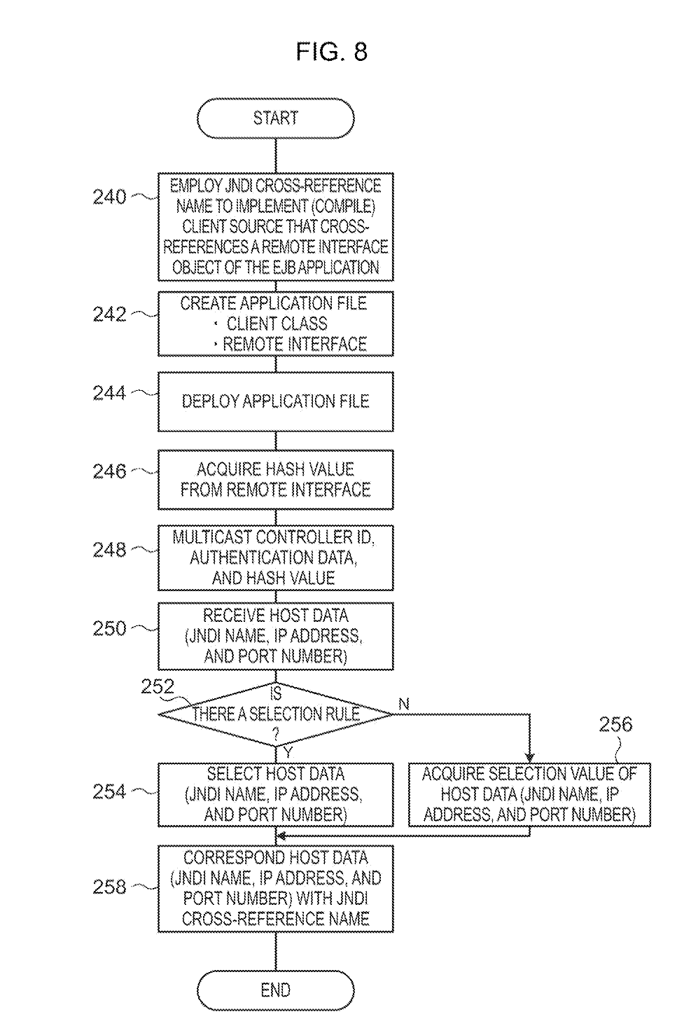

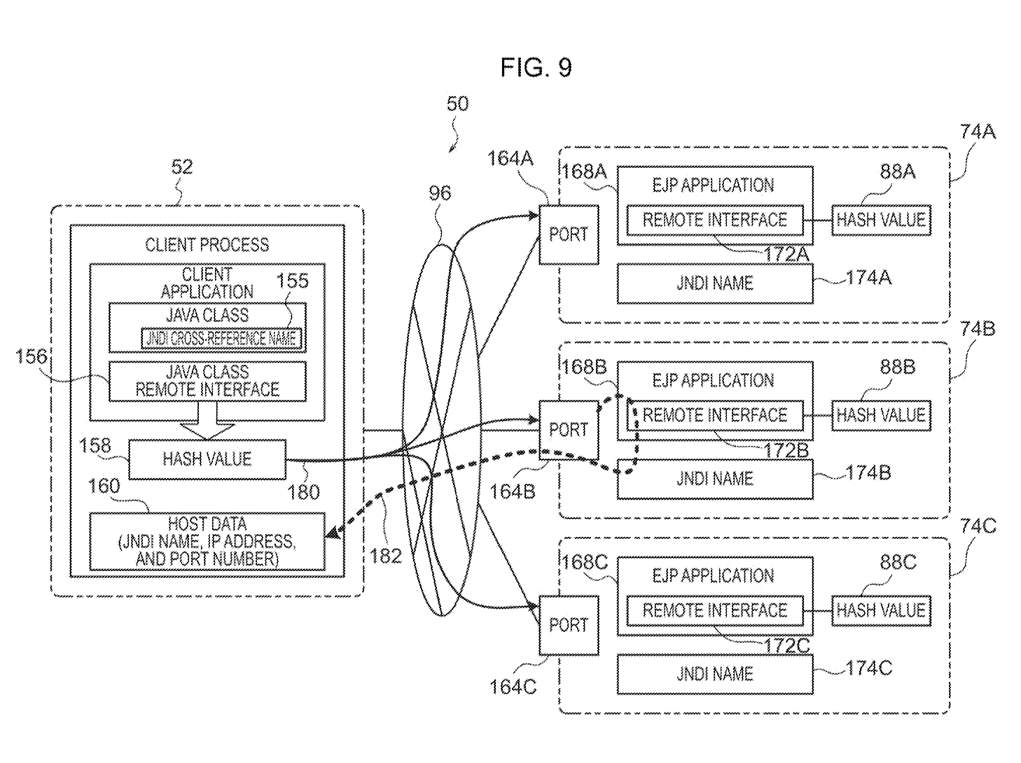

FIG. 8 is a diagram illustrating an example of flow of the association processing that associates the connection data of the EJB application called from the client side, with the call data of the EJB client application executed on the client device 52. FIG. 9 is an explanatory diagram of operation in the computer system 50. FIG. 9 illustrates an example of the computer system 50 that includes the client device 52 and the three server devices 74A to 74C. Association processing to associate the connection data with the call data is executed by the client device 52 when the EJB client application 152 is implemented. The association processing to associate the connection data with the call data is processing performed by a portion of the association program 60, executed as an example of the association program of technology disclosed herein. The association processing between the connection data and the call data, illustrated in FIG. 8, is processing performed by execution of the extraction/computation process 61, the transmission process 62, the receiving process 63, and the correspondence process 64 of the association program 60.

First, the CPU 54 of the client device 52 initiates sequential execution of the extraction/computation process 61, the transmission process 62, the receiving process 63, and the correspondence process 64 of the association program 60. Specifically, the CPU 54 executes the processing routine illustrated in FIG. 8 when the EJB client application 152 is implemented by the client device 52. At step 240, the CPU 54 employs the JNDI cross-reference name 155 and implements (compiles) a client source that cross-references a remote interface object of the EJB application 168, and at step 242, an application file is created. In the creation of the application file, the client class and the remote interface are added. Next, at step 244, the CPU 54 deploys the created application file, namely, puts the application in an employable state. Note that the processes at step 240 to step 244 are executed according to manual procedure by the user, and are known technology for deploying an application file, and detailed explanation thereof is omitted.

Next, at step 246, the CPU 54 acquires the hash value 158 from the remote interface. Namely, the CPU 54 inputs the remote interface into the one-way function, and acquires the hash value 158 by obtaining the computation result, or by employing the serialized value of the remote interface. Next, at step 248, the CPU 54 multicasts (transmits) the controller ID, the authentication data, and the hash value 158 to the server devices 74A to 74C (see also, solid lines 180 illustrated in FIG. 9).

Next, at step 250, the CPU 54 receives the respective host data 160 (the JNDI name, the IP address, and the port number) returned from the server devices 74A to 74C. FIG. 9 illustrates a case in which the hash value 158 and the hash value 88A of the data 172A, representing the contents of the remote interface on the server device 74A, are not the same. This also being a case in which the hash value 158 and the hash value 88C of the data 172C representing the contents of the remote interface on the server device 74C are not the same. This further being a case in which the hash value 158 and the hash value 88B of the data 172B representing the contents of the remote interface on the server device 74B are the same. Accordingly, the server device 74A and the server device 74C do not return the host data 160, and only the server device 74B returns the host data 160 (a dotted line 182 illustrated in FIG. 9).

Next, at step 252, the CPU 54 determines whether or not a selection rule for selecting from plural host data 160 has been defined. The determination processing of step 252 can make a determination by distinguishing whether or not the selection rule has been pre-stored in the storage section 58. An example of the selection rule is a rule whereby data representing processing capacity from the server devices 74A to 74C is acquired, and the server device 74 with the highest processing capacity is selected.

The CPU 54 makes a positive determination at step 252 when the selection rule has been defined, and then, at step 254, the host data 160 is selected according to the selection rule. Conversely, the CPU 54 makes a negative determination at step 252 when the selection rule is not defined, and then, at step 256, a selection value for the host data 160 is acquired through user input, and the host data 160 is selected according to the selection value.

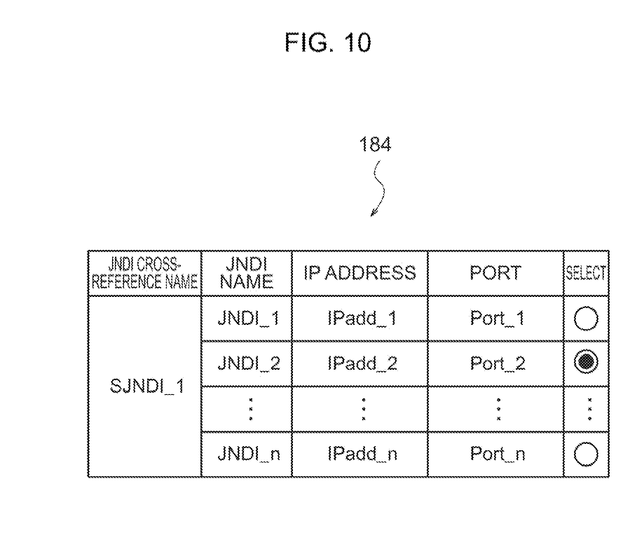

FIG. 10 illustrates a display screen 184 that prompts selection designation input from plural host data 160 presented to the user, as an example of a case where the selection rule is not defined. FIG. 10 illustrates a case where the hash value 88 for the data 172 representing the contents of the remote interface of server device 74 with the JNDI name “JNDI_{—}2” is the selection designated in response to the hash value 158 from the client device 52.

Next, at step 258, the CPU 54 corresponds the host data 160 (the JNDI name, the IP address, and the port number) selected at step 254, or step 256, with the JNDI cross-reference name 155, and the processing routine terminates.

Note that the processing of steps 252 to 256 may be omitted in cases in which the returned host data 160 is a single server device 74 out of the server devices 74A to 74C.

Explanation next follows regarding an example of execution processing of the EJB client application in the client device 52 of the computer system 50.

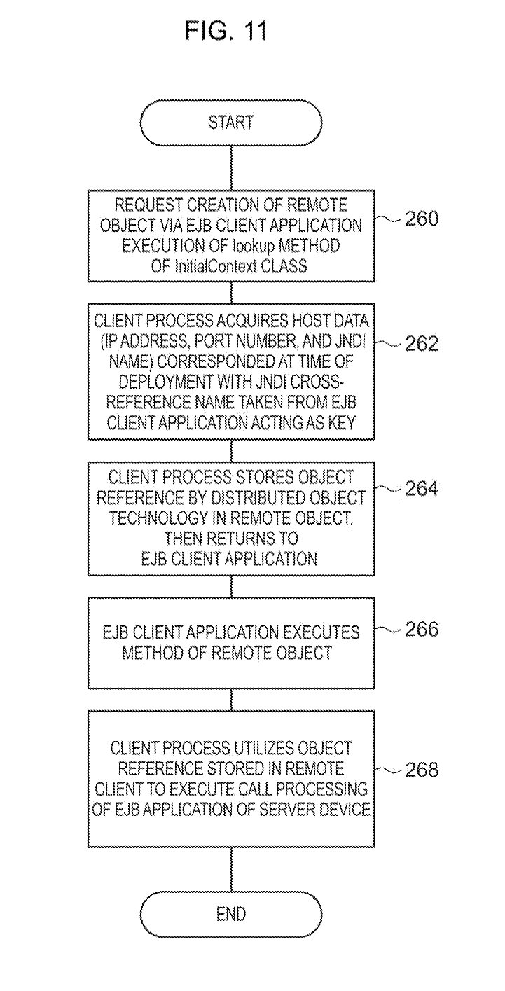

An example of execution processing of the EJB client application in the client device 52 is illustrated in FIG. 11. Note that distributed object technology is used in the processing in FIG. 11.

At step 260, the CPU 54 of the client device 52 requests creation of a remote object via execution of an InitialContext class lookup method by the EJB client application 152. At step 262, the client process 150 of the CPU 54 acquires the host data 160 (the IP address, the port number, and the JNDI name) corresponded at the time of deployment, with the JNDI cross-reference name taken from the EJB client application 152 acting as a key. At step 264, using distributed object technology, the client process 150 of the CPU 54 then, after storing an object reference in the remote object, returns the object reference to the EJB client application 152. At step 266, the EJB client application 152 of the CPU 54 executes the method of the remote object, this being the data 156 representing the contents of the remote interface. At step 268, the CPU 54 causes the client process 150 to execute the call processing of the EJB application 168 of the server device 74, using the object reference stored in the remote object.

Accordingly, the processing illustrated in FIG. 8 enables the EJB application 168 to be called using the corresponding JNDI cross-reference name 155 and the host data 160 when the EJB client application 152 is executed, without incorporating a custom file.

In the present exemplary embodiment, as explained earlier, the EJB client application 152 and the called EJB application 168 have the same remote interface, this being a Java (registered trademark) interface. The client device 52 multicasts the hash value 158 of the remote interface included in the EJB client application 152 to the server devices 74 on the same network segment. Each of the server devices 74 makes a comparison of the hash value 158 against the hash value 88 of the remote interface deployed to that server device itself. The data 174 representing the JNDI name of the EJB application 168 that implements the remote interface is returned to the client device 52 when the hash value 158 and the hash value 88 are the same. The client device 52 selects the EJB application 168 represented by the data 174 representing the JNDI name, according to a selection rule based on a list of the data 174 representing the returned JNDI name, or by user selection.

This thereby enables omission in the EJB client application 152 of the process of pre-incorporating the custom file as a definition file. Since the process of incorporating the custom file as a definition file can be omitted, this enables a reduction in the work to manually confirm that the EJB application 168 corresponds to the remote interface included in the EJB client application 152. Moreover, even in cases in which each of the server devices 74 is constructed according to a customized specification, the EJB application 168 can be automatically selected, or selected merely by designation on a list, for each of the server devices 74 of customized specification.

The hash value 158 of the remote interface included in the EJB client application 152 is multicast to the server devices 74 on the same network segment, and the host data 160 is returned from the server devices 74 having the same hash value 88. This thereby enables execution of a remote call to the EJB application 168, when the contents of the remote interfaces of the EJB application 168 of the server device 74 and of the EJB client application 152 of the client device 52 are the same.

Note that in the present exemplary embodiment, the JNDI cross-reference name 155 is corresponded with the data 174 representing the JNDI name, enabling the client device 52 to acquire the IP address and the port number of the server device 74 that corresponds to the data 174 representing the JNDI name. Specification of the server device 74 that includes the data 174 representing the JNDI name that corresponds to the JNDI cross-reference name 155 is consequently enabled.

The present exemplary embodiment enables storage in the client device 52 of the JNDI cross-reference name 155 and the host data 160 that includes the data 174 representing the JNDI name in the table 66. Accordingly, it is possible to acquire the host data 160 that includes the data 174 representing the JNDI name that corresponds to the JNDI cross-reference name 155 at an earlier stage by referencing the table 66 in the client device 52, enabling suppression of processing load in the client device 52 for specifying the server device 74.

Moreover, in the present exemplary embodiment, in the server device 74, the table 87 is registered with the hash value of the remote interface of the data 174 representing the JNDI name. This thereby enables the presence or absence of the appropriate remote interface to be distinguished in the server device 74 by comparison processing of the hash values by referencing the table 87, enabling processing load on the server device 74 for enquiries (searches) from the client device 52 to be suppressed.

Moreover, in the present embodiment, the JNDI cross-reference name 155 for the EJB application program created to conform to the platform known as EJB, is corresponded against the data 174 representing the JNDI name. It is also possible for the client device 52 to acquire the IP address and the port number of the server device 74 corresponding to the data 174 representing the JNDI name. This thereby enables simple application of technology disclosed herein with the platform known as EJB.

Moreover, in the present embodiment, since the computation result of the one-way function, for example the hash value, is used to distinguish the sameness of the remote interface, this thereby enables the sameness of the remote interfaces to be distinguished according to all data in which changes are expected, including the methods and the parameters.

### Second Exemplary Embodiment

Explanation next follows regarding a second exemplary embodiment of the invention. In the first exemplary embodiment, the data association system 10 is implemented by the computer system 50 that includes the client device 52 and the plural server devices 74, with both the client device 52 and the server devices 74 being connected to the computer network 96. The second exemplary embodiment is an example of a case in which the data association system 10 is implemented by a single computer. Since the second exemplary embodiment is configured similarly to the first exemplary embodiment, the same reference numerals are therefore given to similar portions, and detailed explanation thereof is omitted.

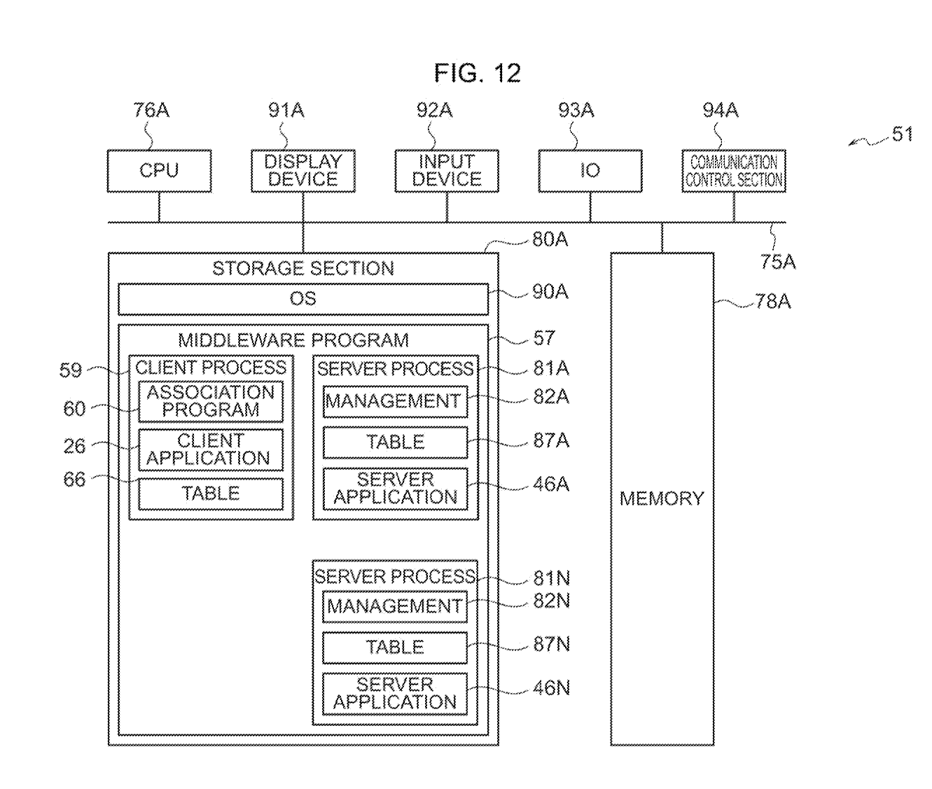

FIG. 12 illustrates an example in which the data association system 10 is implemented by a computer 51. The computer 51 is configured by providing server functionality and client functionality to the server device 74A. Specifically, a middleware program 57, providing basic functionalities that are more application-specific than the OS, is stored in a storage section 80A of the computer 51. A client process 59 and server processes 81A to 81N are each deployed under the middleware program 57. A CPU 76A reads the client process 59 from the storage section 80A and expands the client process 59 into memory 78A. The computer 51 operates as the client device 52, illustrated in FIG. 2, by executing a program provided to the client process 59. The CPU 76A reads the server process 81A from the storage section 80A and expands the server process 81A into memory 78A. The computer 51 operates as the server device 74A, illustrated in FIG. 2, by executing a program provided to the server process 81A. Similarly, the CPU 76A reads each of the server processes 81B to 81N from the storage section 80A and expands the server processes 81B to 81N into the memory 78A, and by executing the program, the computer 51 operates as the server devices 74B to 74N, illustrated in FIG. 2.

In the second exemplary embodiment, the data association system 10 is configured by the computer 51 provided with server functionality and client functionality, meaning that data can be exchanged in a shorter time compared to processing in which communication occurs between independent devices.

Moreover, in the present embodiment, processes are executed by the same CPU 76A, with this enabling equipment differences, such as variation in CPU power that arises when processing is performed by each independent device, to be suppressed.

Note that explanation has been given above of cases in which the data association system 10 is implemented by the computer system 50. However, there is no limitation to the above configuration, and obviously various improvements and modifications may be implemented within a range not departing from the spirit of technology disclosed herein.

Moreover, although explanation has been given above of cases in which the programs described are pre-stored (installed) in a storage section, there is no limitation thereto. For example, it is possible to provide the program of technology disclosed herein in a format recorded on a recording medium such as a CD-ROM or a DVD.

An exemplary embodiment enables data representing a function called by a computation processing device that executes a program to be corresponded with data representing a function cross-referenced by the called function.

All cited documents, patent applications and technical standards mentioned in the present specification are incorporated by reference in the present specification to the same extent as if the individual cited documents, patent applications and technical standards were specifically and individually incorporated by reference in the present specification.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a data association program that causes a computer to execute a process comprising:
transmitting first function data representing a first function called by a first computation processing device that executes a specific program in which a specific function is defined; and
in response to receipt of second function data representing a second function, and identification data representing a second data processing device, from the second data processing device which executes, in accordance with receipt of the transmitted first function data, a program including the second function which is cross-referenced by the first function, associating the second function data and the identification data with the first function data.

2. The non-transitory computer-readable recording medium storing a data association program of claim 1, wherein:
data representing a name of the second function is associated as the second function data, and data representing an IP address and a port number of the second data processing device that the second data processing device employs in communication with the computer is associated as the data representing the second data processing device.

3. The non-transitory computer-readable recording medium storing a data association program of claim 1, wherein:
a table, in which the first computation processing device is associated with the second function data and the identification data, which have been received, and the first function data, is stored in a memory section of the computer.

4. The non-transitory computer-readable recording medium storing a data association program of claim 1, wherein:
the specific program comprises a program that includes a process that executes Enterprise JavaBeans application software.

5. The non-transitory computer-readable recording medium storing a data association program of claim 1, wherein:
first configuration data, representing a result computed by a one-way function input with the first function data, is associated as the first function data; and
the second function data and the identification data are associated with the first function data in response to receipt of the second function data and the identification data representing the second data processing device, from the second data processing device that includes second configuration data that represents a result computed by a one-way function input with the second function data that corresponds to the first configuration data.

6. The non-transitory computer-readable recording medium storing a data association program of claim 1, wherein:
the computer and the second data processing device are configured by the same data processing device.

7. A data association device comprising:
a transmission section that transmits first function data representing a first function called by a first computation processing device that executes a specific program in which a specific function is defined; and
an association sections that, in response to receipt of second function data representing a second function, and identification data representing a second data processing device, from the second data processing device which executes a program including the second function which is cross-referenced by the first function, in accordance with receipt of the transmitted first function data, associates the second function data and the identification data with the first function data.

8. The data association device of claim 7, wherein:
data representing a name of the second function is associated as the second function data, and data representing an IP address and a port number of the second data processing device that the second data processing device employs in communication with the data association device is associated as the data representing the second data processing device.

9. The data association device of claim 7, wherein:
the data association device comprises a memory section that stores a table in which the first computation processing device is associated with the second function data and the identification data, which have been received, and the first function data.

10. The data association device of claim 7, wherein:
the specific program comprises a program that includes a process that executes Enterprise JavaBeans application software.

11. The data association device of claim 7, wherein:
first configuration data, representing a result computed by a one-way function input with the first function data, is associated as the first function data; and
the association section associates the second function data and the identification data with the first function data in response to receipt of the second function data and the identification data representing the second data processing device, from the second data processing device that includes second configuration data that represents a result computed by a one-way function input with the second function data that corresponds to the first configuration data.

12. The data association device of claim 7, wherein:
the data association device and the second data processing device are configured by the same data processing device.

13. A data association system that executes a process, wherein:
a first data processing device transmits first function data representing a first function called by a first computation processing device that executes a specific program in which a specific function is defined;
a second data processing device that executes a program including a second function that is cross-referenced by the first function transmits second function data representing a second function, and identification data representing the second data processing device; and
the first data processing device associates the second function data and the identification data, which have been received, with the first function data.

14. The data association system of claim 13, wherein:
data representing a name of the second function is associated as the second function data, and data representing an IP address and a port number of the second data processing device that the second data processing device employs in communication with the first data processing device is associated as the data representing the second data processing device.

15. The data association system of claim 13, wherein:
the first data processing device comprises a memory section that stores a table in which the first computation processing device is associated with the second function data and the identification data, which have been received, and the first function data.

16. The data association system of claim 13, wherein:
the second data processing device comprises a memory section that stores a correspondence relationship, in which the first function data is associated with the second function data.

17. The data association system of claim 13, wherein:
the specific program comprises a program that includes a process that executes Enterprise JavaBeans application software.

18. The data association system of claim 13, wherein:
first configuration data, representing a result computed by a one-way function input with the first function data, is associated as the first function data; and
the second function data and the identification data are associated with the first function data in response to receipt of the second function data and the identification data representing the second data processing device, from the second data processing device that includes second configuration data that represents a result computed by a one-way function input with the second function data that corresponds to the first configuration data.
